(19) United States
(12) Patent Application Publication
(10) Pub. No.: US 2010/0253226 A1
(43) Pub. Date: Oct. 7, 2010

(54) ENERGY-SAVING LIGHTING FIXTURE

(76) Inventor: Isamu OKI, Tainan City (TW)

Correspondence Address: BERENATO & WHITE, LLC, 6550 ROCK SPRING DRIVE, SUITE 240, BETHESDA, MD, 20817, US

(21) Appl. No.: 12/547,850

(22) Filed: Aug. 26, 2009

(30) Foreign Application Priority Data
Apr. 6, 2009 (TW) 098111363

(51) Int. Cl. H01J 61/52; F21S 4/00

(52) U.S. Cl. 315/113; 362/249.01; 362/249.02; 362/260

(57) ABSTRACT

An energy-saving lighting fixture includes a light transmissive tubular enclosure including an inner tube defining an inner compartment therein, and an outer tube disposed around and spaced apart from the inner tube to define an outer compartment therebetween. As such, the tubular enclosure has a double-tube structure. A lamp assembly includes at least one lamp device disposed fixedly in the inner compartment of the tubular enclosure.

### CROSS-REFERENCE TO RELATED APPLICATION

This application claims priority of Taiwanese Application No. 098111363, filed on Apr. 6, 2009.

### BACKGROUND OF THE INVENTION

1. Field of the Invention

The invention relates to a lighting fixture, more particularly to a lighting fixture capable of saving energy.

2. Description of the Related Art

In recent years, for the purposes of environmental protection and economization of power consumption, light emitting diode (LED) lamp tubes have replaced fluorescent tubes. Numerous of literatures have disclosed configurations of LED lamp tubes, in each of which a heat-dissipating unit configured as a semi-cylinder or a rectangle is attached to LEDs of the lamp tube to conduct heat-dissipation. However, the heat-dissipating unit affects adversely illumination of the lamp tube, hence the light output angle range is limited to about 180°, that results in a waste of energy. Since an enclosure of the lamp tube is a single-tube structure, heat generated by the LEDs conducts to the enclosure directly, thus increasing temperature of the lamp tube. As a result, the heat-insulation ability of the LED lamp tubes is poor, and the application range of the lamp tubes is limited.

### SUMMARY OF THE INVENTION

Therefore, the object of the present invention is to provide a lighting fixture that can save energy.

According to the present invention, there is provided an energy-saving lighting fixture comprising a light transmissive tubular enclosure including an inner tube defining an inner compartment therein, and an outer tube disposed around and spaced apart from the inner tube to define an outer compartment therebetween. As such, the tubular enclosure has a double-tube structure. A lamp assembly includes at least one lamp device disposed fixedly in the inner compartment of the tubular enclosure.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a first preferred embodiment of an energy-saving lighting fixture according to the present invention;

FIG. 2 is an exploded perspective view of the energy-saving lighting fixture of the first preferred embodiment;

FIG. 3 is a partly sectional view of the energy-saving lighting fixture of the first preferred embodiment;

FIG. 4 is a schematic sectional view of the energy-saving lighting fixture of the first preferred embodiment;

FIG. 5 is a partly sectional view of a second preferred embodiment of an energy-saving lighting fixture according to the present invention;

FIG. 6 is a top view of the energy-saving lighting fixture of a third preferred embodiment, illustrating arrangement of a plurality of lamp devices on a circuit board when laid flat on a plane;

FIG. 7 is a partly exploded perspective view of a fourth preferred embodiment of an energy-saving lighting fixture according to the present invention;

FIG. 8 is an exploded perspective view of a fifth preferred embodiment of an energy-saving lighting fixture according to the present invention; and

FIG. 9 is a fragmentary partly sectional view of the fifth preferred embodiment.

### DETAILED DESCRIPTION OF THE PREFERRED EMBODIMENTS

Before the present invention is described in greater detail, it should be noted that like elements are denoted by the same reference numerals throughout the disclosure.

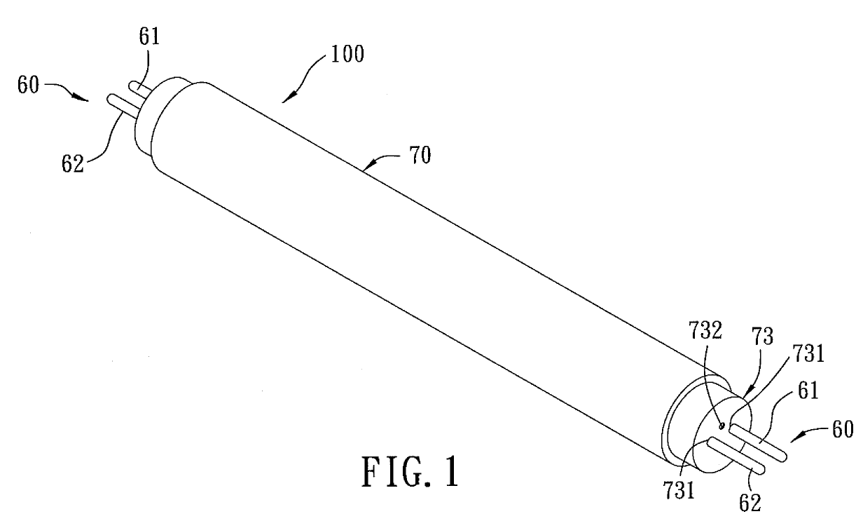

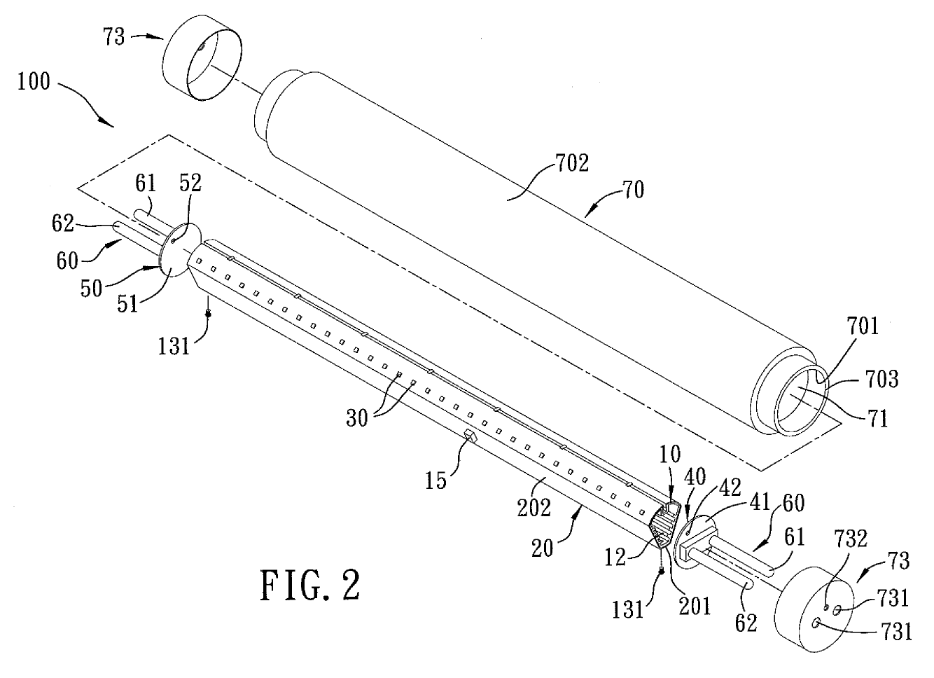

FIGS. 1 and 2 show a first preferred embodiment of an energy-saving lighting fixture 100 according to the present invention. The lighting fixture 100 comprises a heat-dissipating strip 10, a circuit board 20, a lamp assembly including a plurality of lamp devices 30, two control modules 40, 50, two input terminals 60, and a light transmissive tubular enclosure 70.

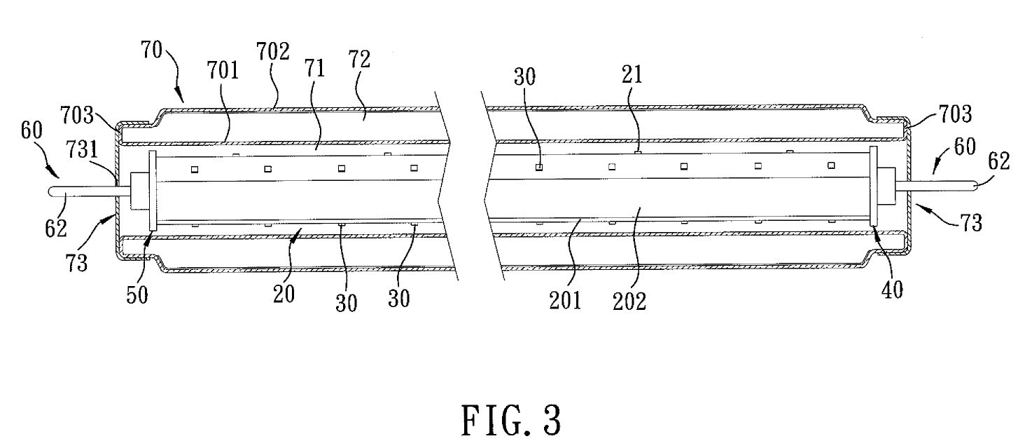

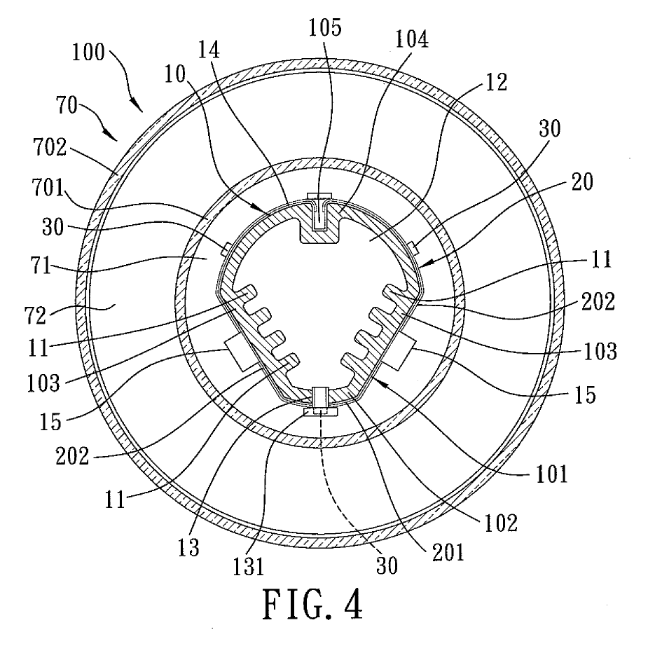

Further referring to FIGS. 3 and 4, the light transmissive tubular enclosure 70 includes an inner tube 701 defining an inner compartment 71 therein, and an outer tube 702 disposed around and spaced apart from the inner tube 701 to define an outer compartment 72 therebetween, such that the tubular enclosure 70 has a double-tube structure. In this preferred embodiment, the inner compartment 71 has two opposite open ends. The tubular enclosure 70 is made of a light transmissive material such as glass.

The circuit board 20 is disposed in the inner compartment 71 of the tubular enclosure 70. The lamp devices 30 are disposed fixedly in the inner compartment 71, connected fixedly to an outer surface of the circuit board 20, and arranged in three rows. The lamp devices 30 in each row are aligned respectively with those in an adjacent row along a circumferential direction of the tubular enclosure 70. In this preferred embodiment, the lamp devices 30 are light emitting diodes (LEDs) The projection angle of each LED is approximately 120° , such that three rows of LEDs provide a 360° illumination.

The heat-dissipating strip 10 includes a tubular strip body 101 defining a heat-dissipating compartment 12 therein, and a plurality of heat-dissipating fins 11 extending from an inner surface of the tubular strip body 101 toward the heat-dissipating compartment 12.

The tubular strip body 101 of the heat-dissipating strip 10 has a base segment 102, two flat segments 103 having a lower end connected to the base segment 102, and a connecting segment 104 interconnecting upper ends of the two flat segments 103 and formed with channel 105 at a middle portion thereof. The base segment 102 has an outer surface coated with an insulating colloidal layer 14. The base segment 102 further has two fixing holes 13 formed at two opposite ends thereof and in fluid communication with the heat-dissipating compartment 12.

In this preferred embodiment, the circuit board 20 is a flexible printed circuit board and configured as a tube. The heat-dissipating strip 10 is disposed in and in contact with the circuit board 20. The heat-dissipating strip 10 further includes two screws 131 respectively extending through the through holes 13 and threaded into the circuit board 20 and the heat-dissipating strip 10.

The circuit board 20 has a plurality of semiconductor elements 15 such as resistors, a base board portion 201 aligned with the base segment 102, and two flat board portions 202 aligned with the flat segments 103, respectively. A portion of each of the semiconductor elements 15 extends through the flat board portion 202 and is adhered to the insulating colloidal layer 14 by a resin slice (not shown). The configuration of the flat segments 103 and the flat board portions 202 increases a contact area between the semiconductor elements 15 and the flat segments 103 to thereby increase heat-dissipating ability thereof. Heat generated by the lamp devices 30 and components of the circuit board 20 (including the semiconductor elements 15) is dissipated into the heat-dissipating compartment 12 via the heat-dissipating strip 10.

The control modules 40, 50 are disposed to connect with two opposite ends of the tubular circuit board 20, respectively. Each of the control modules 40, 50 has a base seat 41, 51 connected to the circuit board 20 and a heat-dissipating hole 42, 52 in fluid communication with the heat-dissipating compartment 12. The control modules 40, 50 can convert the input current (alternative current) into direct current to thereby turn on/off the lamp devices 30.

Each of the input terminals 60 has two spaced apart electrode pins 61, 62 and is connected electrically to a respective one of the control modules 40, 50. The electrode pins 61, 62 connect to an electric socket (not shown) to conduct the direct current to the lamp devices 30.

The tubular enclosure 70 further includes two spaced-apart connecting walls 703 interconnecting the inner tube 701 and the outer tube 702 to close two ends of the outer compartment 72. It should be noted that the outer compartment 72 may not be sealed in other embodiments.

Two cap bodies 73 are disposed to seal two open ends of the tubular enclosure 70, respectively. Each of the cap bodies 73 is formed with two through holes 731. The electrode pins 61, 62 of the input terminals 60 extend respectively through the through holes 731 of the cap bodies 73. Each of the cap bodies 73 is further formed with a ventilating hole 732 in fluid communication with the heat-dissipating hole 42, 52 of a corresponding one of the control modules 40, 50 and, thus, the heat-dissipating compartment 12.

It should be noted that the tubular enclosure 70 is formed integrally in this preferred embodiment. Alternatively, the inner tube 701 and the outer tube 702 are formed individually and are interconnected by a glass-welding process.

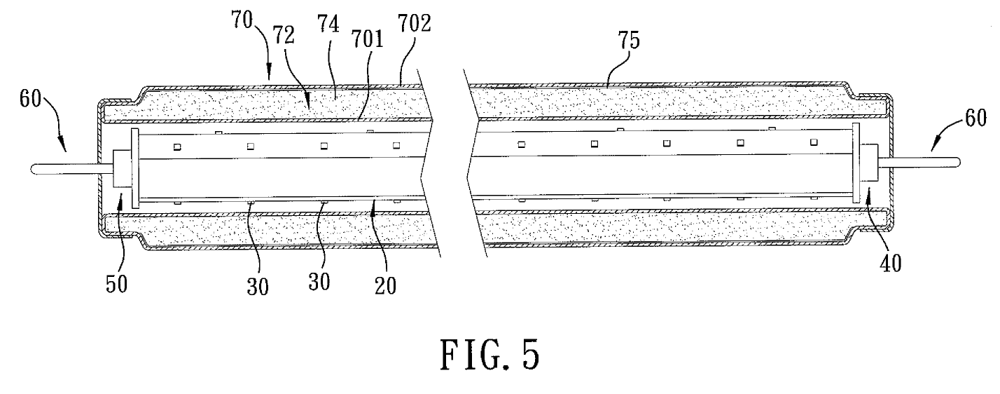

Referring to FIG. 5, a second preferred embodiment of an energy-saving lighting fixture 100 according to the present invention has a structure similar to that of the first embodiment. The main difference between this embodiment and the first embodiment resides in the following. The outer compartment 72 is filled with gas 74. In this preferred embodiment, an inert gas such as Argon is filled into the compartment 72. Since the gas 74 insulates the heat generated by the lamp devices 30, the heat will not be conducted to the outer tube 702 directly. The outer tube 702 can be maintained under 45° C. Furthermore, the gas 74 absorbs heat from the inner tube 701.

The tubular enclosure 70 may be adhered with a protective film (not shown) on an outer surface of the outer tube 702. If this occurs, once the lighting fixture 100 is dropped onto a floor and broken into pieces, the protective film can prevent separation of the broken pieces from each other. The tubular enclosure 70 is applied with a fluorescent coating 75. The fluorescent coating 75 is applied on a surface of the outer tube 702 that faces the outer compartment 72. Light beams generated by the lamp devices 30 emit through the gas 74 and are absorbed by the fluorescent coating 75 so as to generate other light beams that cooperate with those emitted from the lamp devices 30 to provide a light output similar to that of conventional fluorescent lighting fixtures, which can provide comforting feeling to the eyes of the user. An outer surface of the tubular enclosure 70 may be further processed into a rough surface that ensures a softer light output. The second preferred embodiment has the same advantages as those of the first preferred embodiment.

It should be noted that the fluorescent coating 75 may be omitted in other embodiments. The heat-dissipating strip 10, the circuit board 20, the lamp devices 30, the control modules 40, 50, and the input terminals 60 are integrated into an assembly, which can be inserted into the tubular enclosure 70 during installation. Hence, the installation of the energy-saving lighting fixture 100 is simple. The fluorescent coating 75 can be applied on a surface of the inner tube 701 that faces the outer compartment 72. Therefore, the components of the circuit board 20 will not scrape the fluorescent coating 75 during installation. Since the heat-dissipating strip 10 is disposed in the circuit board 20 fittingly, a heat exchanging area is increased so that the heat dissipating ability of the lighting fixture 100 can be improved.

A light dispersion of a conventional LED lighting fixture is limited to the projection angle of each LED, that is approximately 120°. Since the circuit board 20 is flexible and configured as a tube, the lamp devices 30 mounted on the circuit board 20 provide a 360° illumination. It should be noted that a printed circuit board (PCB) may be employed in other embodiments. Though the PCB cannot be rolled up, four PCBs mounting LEDs can be arranged into a square tube and connected to each other so as to provide a 360° illumination.

To sum up, the advantages of the energy-saving lighting fixture 100 according to the present invention are as outlined in the following. The configuration of the double-tube tubular enclosure 70 provides an insulation of heat that is generated by the lamp devices 30 from the inner tube 701 to the outer tube 702. Referring to FIGS. 2 and 5, the tubular design of the heat-dissipating strip 10 disposed in the circuit board 20 increases the heat-dissipating area to thereby ensure an effective heat-dissipation of the energy-saving lighting fixture 100.

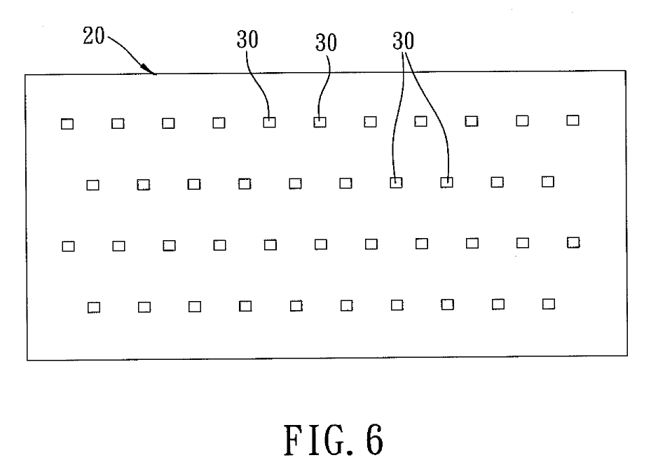

As shown in FIG. 6, a third preferred embodiment of an energy-saving lighting fixture 100 (not shown) according to the present invention has a structure similar to that of the first embodiment. FIG. 6 illustrates arrangement of the lamp devices 30 on the circuit board 20 when laid flat on a plane. The main difference between this embodiment and the first embodiment resides in that the arrangement of the lamp devices 30 are modified and arranged in four rows on the circuit board 20. The lamp devices 30 in each row are misaligned respectively from the lamp devices 30 in an adjacent row along the circumferential direction of the tubular enclosure 70. The third preferred embodiment has the same advantages as those of the first preferred embodiment.

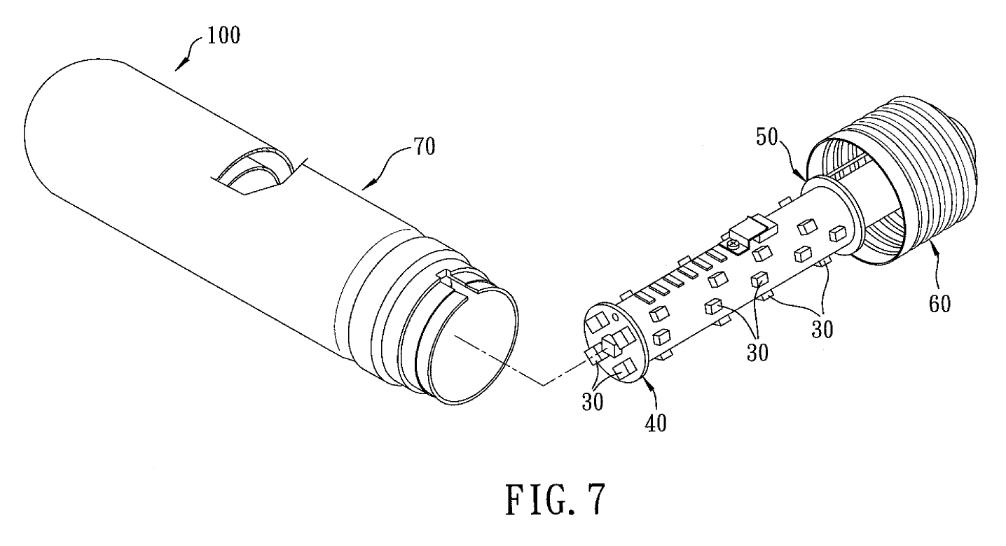

As shown in FIG. 7, a fourth preferred embodiment of the energy-saving lighting fixture 100 according to the present invention has a structure similar to that of the third embodiment. The main difference between this embodiment and the third embodiment resides in the following. The lamp devices 30 are light bulbs. Only one input terminal 60 is required in this embodiment. The input terminal 60 is mounted to the tubular enclosure 70 and electrically connected to the control module 50. Additional lamp devices 30 are mounted on an outer surface of the left control module 40 to increase illumination of the lighting fixture 100 at an end of the tubular enclosure 70. The fourth preferred embodiment has the same advantages as those of the first preferred embodiment.

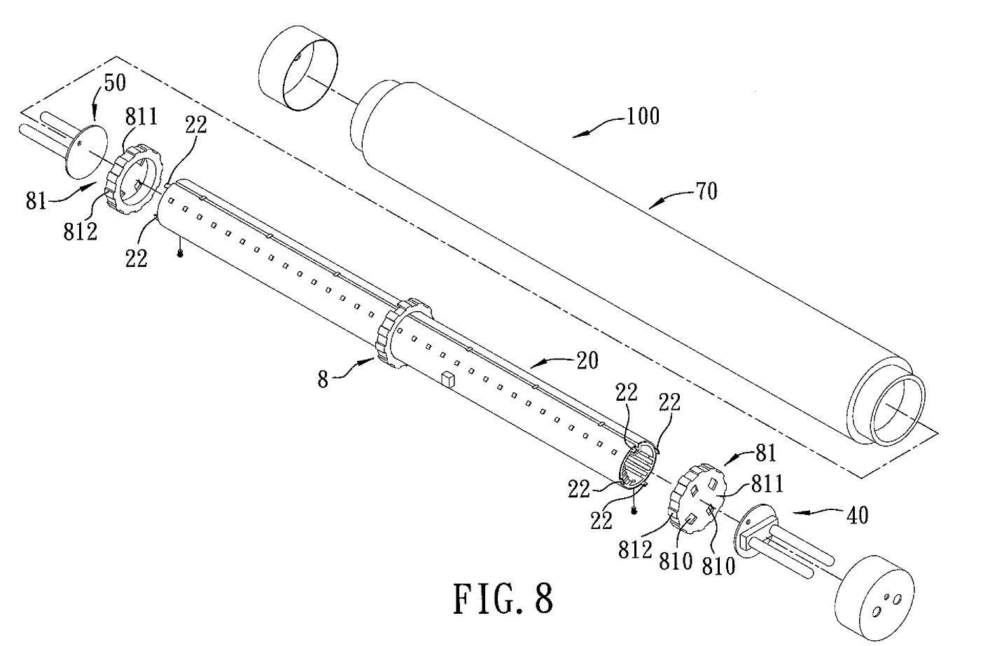

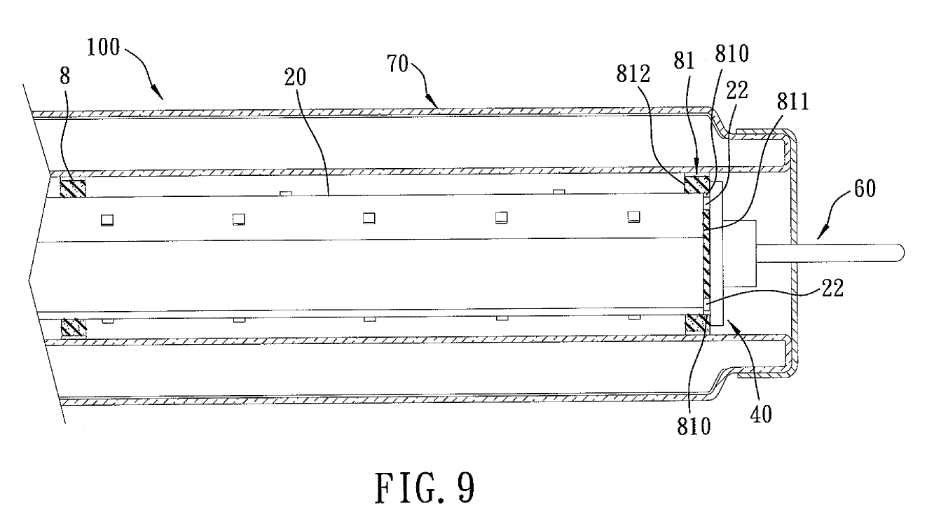

As shown in FIGS. 8 and 9, a fifth preferred embodiment of the energy-saving lighting fixture 100 according to the present invention has a structure similar to that of the first embodiment. The main difference between this embodiment and the third embodiment resides in the following. The lighting fixture 100 further comprises a washer 8 sleeved on the circuit board 20 in a close fitting manner. Two end caps 81 are disposed respectively at two opposite ends of the circuit board 20. Each of the end caps 81 has an end wall 811 abutting against a corresponding one of the ends of the circuit board 20 and an annular wall 812 extending from the end wall 811 and sleeved on the corresponding one of the ends of the circuit board 20 in a close fitting manner. Each of the end walls 811 of the end caps 81 has four spaced apart mounting holes 810 that are provided for heat-dissipating and that allow a plurality of conductive wires 22 of the circuit board 20 to extend therethrough for electrical connection with the control modules 40, 50. The end caps 81 and the washer 8 are made of resin, so that the tubular shape of the circuit board 20 can be maintained. The washer 8 and the end caps 81 are mounted between the circuit board 20 and the tubular enclosure 70 in a close fitting manner to serve as cushions, thereby preventing the circuit board 20 from vibrating or scraping the tubular enclosure 70. The fifth preferred embodiment has the same advantages as those of the first preferred embodiment.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An energy-saving lighting fixture comprising:
a light transmissive tubular enclosure including an inner tube defining an inner compartment therein, and an outer tube disposed around and spaced apart from said inner tube to define an outer compartment therebetween, such that said tubular enclosure has a double-tube structure; and
a lamp assembly including at least one lamp device disposed fixedly in said inner compartment of said tubular enclosure.

2. The energy-saving lighting fixture as claimed in claim 1 further comprising a circuit board disposed in said inner compartment of said tubular enclosure, said lamp assembly including a plurality of said lamp devices disposed on said circuit board and arranged in rows.

3. The energy-saving lighting fixture as claimed in claim 1 further comprising a tubular circuit board disposed in said inner compartment of said tubular enclosure, said lamp device being connected fixedly to an outer surface of said circuit board.

4. The energy-saving lighting fixture as claimed in claim 3, wherein said circuit board is a flexible printed circuit board.

5. The energy-saving lighting fixture as claimed in claim 4, further comprising a washer sleeved on said circuit board in a close fitting manner.

6. The energy-saving lighting fixture as claimed in claim 5, wherein said washer is made of resin.

7. The energy-saving lighting fixture as claimed in claim 4, further comprising two end caps disposed respectively at two opposite ends of said circuit board, each of said end caps having an end wall abutting against a corresponding one of said ends of said circuit board and an annular wall extending from said end wall and sleeved on said corresponding one of said ends of said circuit board in a close fitting manner.

8. The energy-saving lighting fixture as claimed in claim 7, wherein said end caps are made of resin.

9. The energy-saving lighting fixture as claimed in claim 3 further comprising a heat-dissipating strip disposed in and in contact with said circuit board.

10. The energy-saving lighting fixture as claimed in claim 9, wherein said heat-dissipating strip includes a tubular strip body defining a heat-dissipating compartment therein, and a plurality of heat-dissipating fins extending from an inner surface of said tubular strip body toward said heat-dissipating compartment.

11. The energy-saving lighting fixture as claimed in claim 10, wherein said tubular strip body of said heat-dissipating strip has a base segment, and at least one flat segment connected to said base segment, said circuit board having a base board portion aligned with said base segment, and at least one flat board portion aligned with said flat segment.

12. The energy-saving lighting fixture as claimed in claim 10, wherein said base segment has an outer surface coated with an insulating colloidal layer.

13. The energy-saving lighting fixture as claimed in claim 3, further comprising two control modules disposed to connect with two opposite ends of said tubular circuit board, and at least one power terminal connected electrically to said control modules.

14. The energy-saving lighting fixture as claimed in claim 13, further comprising two input terminals each of which has two spaced apart electrode pins and which are connected respectively and electrically to said control modules, and two cap bodies being disposed to seal two ends of said tubular enclosure, respectively, each of said cap bodies being formed with two through holes, said electrode pins of said input terminals extending respectively through said through holes of said cap bodies.

15. The energy-saving lighting fixture as claimed in claim 14, further comprising a heat-dissipating strip disposed in said circuit board and defining a heat-dissipating compartment, each of said control modules having a heat-dissipating hole being in fluid communication with said heat-dissipating compartment, each of said cap bodies having a ventilating hole being in fluid communication with said heat-dissipating hole of a corresponding one of said control modules and, thus, said heat-dissipating compartment.

16. The energy-saving lighting fixture as claimed in claim 1, wherein said lamp device is a light emitting diode (LED).

17. The energy-saving lighting fixture as claimed in claim 1, wherein said tubular enclosure further includes two spaced-apart connecting walls interconnecting said inner tube and said outer tube to close two ends of said outer compartment.

18. The energy-saving lighting fixture as claimed in claim 17, wherein said outer compartment is filled with gas.

19. The energy-saving lighting fixture as claimed in claim 1, wherein said tubular enclosure is applied with a fluorescent coating, said fluorescent coating being applied on a surface of one of said inner tube and said outer tube that faces said outer compartment.
